(19) United States
(12) Patent Application Publication
(10) Pub. No.: US 2026/0169949 A1
(43) Pub. Date: Jun. 18, 2026

(54) ADDRESS ASSIGNMENT SYSTEM AND METHOD IN A DIGITAL COMMUNICATION INTERFACE

(71) Applicant: STMicroelectronics International N.V., Geneva (CH)

(72) Inventors: Daniele Arceri, Roma (IT); Eyuel Zewdu Teferi, Milan (IT); Davide Magnoni, Varese (IT)

(21) Appl. No.: 19/400,270

(22) Filed: Nov. 25, 2025

(30) Foreign Application Priority Data
Dec. 12, 2024 (IT) 102024000028275

(51) Int. Cl. G06F 13/42

(52) U.S. Cl. CPC G06F 13/4282; G06F 2213/0016

(57) ABSTRACT

A digital system has a master device and a plurality of slave devices coupled to the master device on a shared data communication bus. Each slave device includes an address selection pin, configured to be addressed by the master device for a data communication on the shared data communication bus, and a detection stage, coupled to the address selection pin to detect a static address associated with the address selection pin. The detection stage determines the static address as a function of a respective one of different pull-up and/or pull-down connection modes of the address selection pin. The pull-up and/or pull-down connection modes differ from each other based on a different resistance associated with the pull-up and/or pull-down connection.

### CROSS-REFERENCE TO RELATED APPLICATIONS

This application claims the priority to Italian Application No. 102024000028275, filed on Dec. 12, 2024, which application is hereby incorporated herein by reference.

### TECHNICAL FIELD

The present solution relates to an address assignment system in a digital communication interface and to a corresponding method.

In particular, the following discussion will refer, without losing generality, to a serial interface, more in particular operating according to the I2C (Inter Integrated Circuit) or I3C (Improved Inter Integrated Circuit) protocol defined by the MIPI (Mobile Industry Processor Interface) alliance.

### BACKGROUND

Digital communication interfaces are commonly used, for example in embedded electronic systems, to implement digital communication between a master or host device (e.g., a digital processor or controller) and a certain number of slave devices coupled to a same digital communication bus or line (e.g., operating with the I2C or I3C serial protocol) and which may be individually addressed by the master device.

Each slave device needs to be provided with a unique static address, to allow the master device to correctly address communication data towards the same slave device; consequently, in case a plurality of slave devices are connected to the same communication bus, a corresponding number of different addresses is required.

For instance, the multiple slave devices coupled to the same bus may be sensor devices, of the MEMS (Micro-Electro-Mechanical Systems) type, which may be specialized for different functions and managed or controlled by a same master device, for example by a control unit of an electronic apparatus, for example of a portable or mobile type, wherein the same sensor devices are used. The use of a different static address for each sensor device allows the control unit to recognize each slave device and establish a targeted communication with the same slave device through the communication bus.

Various solutions have been proposed to obtain the desired plurality of static addresses for addressing a corresponding plurality of slave devices.

For instance, a known solution envisages the use, for each slave device, of a plurality of addressing or address selection pins (typically referred to as SA, Static Address, pins), each of which may be connected to ground or earth, or to a similar reference voltage, thereby having a first logic value, for example low ‘0’; or to a supply voltage, thereby having a second logic value, for example high ‘1’.

This solution has the advantage of being simple to implement, but the disadvantage that a single pin allows addressing of only two devices (thus requiring, for example, the use of three digital pins for addressing six different slave devices).

A large number of static address selection pins may not be implementable in the case of devices which require a reduced space occupation or in general a reduced resource occupation (such as for example in the case of MEMS sensor devices).

Another known solution envisages the use of a single address selection pin, which may be set to several and different voltage levels, each of which corresponds to a different static address.

Although it allows addressing of several slave devices by a single address selection pin, this solution has however the disadvantage of requiring, within the slave devices, the implementation of an ADC (Analog to Digital Converter) to determine the voltage level associated with the address selection pin and also, externally to the slave devices, the generation of the aforementioned different voltage levels to which the address selection pin have to be set.

Therefore, also this solution may be difficult to implement in case of devices requiring a reduced resource occupation (such as for example in the case of the aforementioned MEMS sensor devices).

Further known solutions for addressing different slave devices have generally greater complexity and area occupation, requiring the use of additional components, such as for example counters or the like.

### SUMMARY

The present solution generally aims to overcome the limitations of known systems and to provide an answer to the aforementioned need for assigning addresses, in particular static addresses, for a plurality of devices on a same digital communication interface bus.

According to the present solution, a system and a method are therefore provided, as defined in the attached claims.

### BRIEF DESCRIPTION OF THE DRAWINGS

For a better understanding of the present invention, a preferred embodiment thereof is now described, purely by way of non-limiting example and with reference to the attached drawings, wherein:

FIG. 1 schematically shows a digital system comprising a master device and a plurality of slave devices coupled to a same interface bus;

FIG. 2 shows a block diagram of a slave device, with a corresponding static address assignment system;

FIG. 3 shows a flow chart of address assignment operations;

FIG. 4 shows signal diagrams corresponding to address assignment operations;

FIG. 5 shows an address selection table, which may be implemented in a possible embodiment of the system; and

FIGS. 6A-6C show circuit diagrams corresponding to an output block of the slave device, in different operating configurations.

### DETAILED DESCRIPTION OF ILLUSTRATIVE EMBODIMENTS

As will be described in detail below, one aspect of the present solution generally envisages implementing different static address assignments for slave devices, using respective different pull-up connection modes (i.e., to a supply terminal) and/or pull-down connection modes (i.e., to a reference or ground terminal) of at least one addressing (or address selection) pin of the slave device. In particular, such address selection pin is coupled, internally to the slave device, to a digital input/output pad provided, in an embedded manner, with controllable pull-up and/or pull-down features.

The present solution thereby allows for assigning different static addresses to a plurality of slave devices connected on a same communication bus to a master device, even using only one single address selection pin.

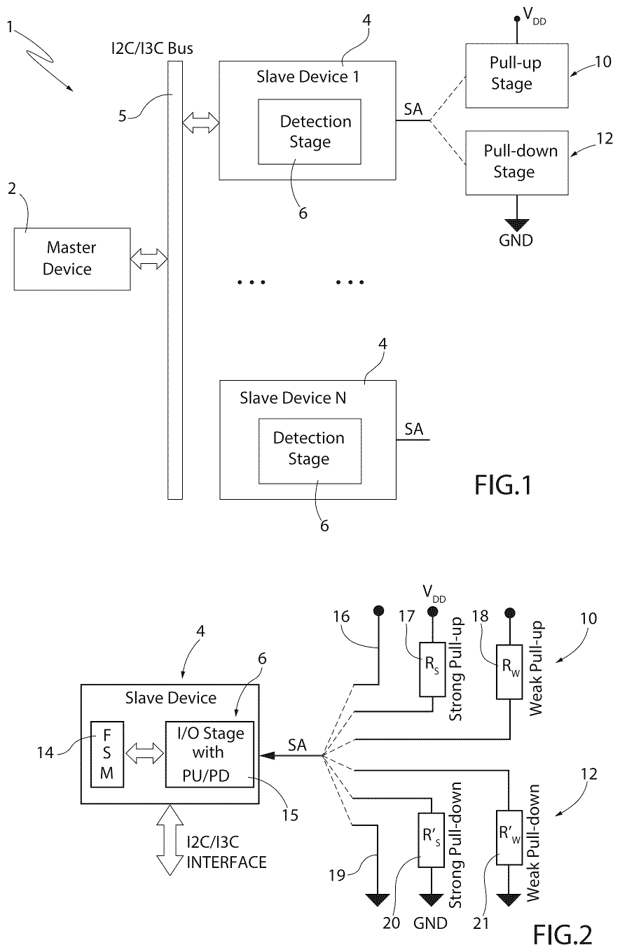

In this regard, FIG. 1 shows a digital system 1, which comprises a master (or host) device 2, which communicates with a certain number of slave devices 4 (in the example in a number equal to N, indicated as Device 1-Device N) on a same digital communication (or interface) bus 5, for example operating according to the I2C or I3C protocol (including, in a known and not illustrated manner, at least one bidirectional data communication line between the slave devices 4 and the master device 2 and a clock line which carries at least one synchronization signal).

Each slave device 4 comprises at least one static addressing, or address selection, pin (hereinafter referred to as SA pin), i.e., a pin accessible from the outside of the slave device 4; according to one aspect of the present solution, each slave device 4 comprises only one, single, SA pin.

In particular, as will be described in detail below, the SA pin is coupled to a digital input/output stage (or pad) in the slave device 4, internally provided, in an embedded manner, with a controllable pull-up and/or pull-down feature (i.e., such SA pin may be connected, internally to the slave device 4, to a supply terminal or to a reference or ground terminal by a pull-up or pull-down internal resistance).

Each slave device 4 also comprises, in an embedded manner, a detection stage 6, coupled to the SA pin and configured to detect a static address associated with the same SA pin.

The digital system 1 comprises, externally to the slave devices 4, a pull-up stage 10, that may be coupled to the SA pin and configured to define at least two different pull-up connection modes of the same SA pin towards a supply terminal V_{DD}, set at a supply voltage of the same digital system 1 (by way of example, FIG. 1 shows this pull-up stage 10 coupled to only one of the slave devices 4).

In particular, each of these pull-up connection modes corresponds to a different “strength” of the connection towards the supply terminal V_{DD}, i.e., to a different pull-up resistance which connects the SA pin towards the same supply terminal V_{DD}.

The digital system 1 also comprises, externally to the slave devices 4, a pull-down stage 12, that may be coupled to the SA pin and configured to define at least two different pull-down connection modes of the same SA pin towards a reference or ground terminal GND of the same digital system 1 (by way of example, FIG. 1 shows this pull-down stage 12 coupled to only one of the slave devices 4).

In particular, each of these pull-down connection modes corresponds to a different “strength” of the connection towards the ground terminal GND, i.e., to a different pull-down resistance which connects the SA pin towards the same ground terminal GND.

According to one aspect of the present solution, the aforementioned detection stage 6 of each slave device 4 is configured to implement a sequence of checks associated with the SA pin to detect the mode with which the same SA pin is externally connected to the supply terminal V_{DD} and/or to the ground terminal GND and, consequently, determine a static address assigned to the same SA pin.

In a possible implementation, such detection stage 6 may be able to detect up to six different connection modes of the SA pin and corresponding different static addresses, namely:
SA pin directly connected to the supply terminal V_{DD};
SA pin connected to the supply terminal V_{DD} through a weak pull-up (with a corresponding resistive element);
SA pin connected to the supply terminal V_{DD} through a strong pull-up (with a corresponding resistive element);
SA pin connected to the ground terminal GND through a strong pull-down (with a corresponding resistive element);
SA pin connected to the ground terminal through a weak pull-down (with a corresponding resistive element); and
SA pin directly connected to the ground terminal.

FIG. 2 shows, in this implementation, a slave device 4 (by way of example), wherein the aforementioned detection stage 6 comprises a digital logic unit 14, in particular configured to implement a Finite State Machine (FSM).

The slave device 4 also comprises a digital input/output (I/O) stage (or pad) 15, provided with embedded pull-up and pull-down, which is connected (in input and output) to the SA pin.

In particular, the digital logic unit 14 (which, in a manner not illustrated, may be part of or be operatively coupled to a control unit of the slave device 4, configured to control its general operation) is operatively coupled to the digital I/O stage 15 and is configured to control such digital I/O stage 15 during the aforementioned sequence of checks associated with the SA pin and aimed at determining the corresponding static address.

In the illustrated implementation example, the aforementioned pull-up stage 10 comprises, selectively coupled to the SA pin: a direct connection line 16 to the supply terminal V_{DD}; a first pull-up resistive element 17, having a first resistance value Rₛ, defining a strong pull-up connection towards the supply terminal V_{DD}; and a second pull-up resistive element 18, having a second resistance value R_{w}, defining a weak pull-up connection towards the same supply terminal V_{DD} (the second resistance value R_{w} being higher than the first resistance value Rₛ, for example even by two orders of magnitude higher).

Similarly, the aforementioned pull-down stage 12 comprises, selectively coupled to the SA pin: a direct connection line 19 to the ground terminal GND; a first pull-down resistive element 20, having a respective first resistance value Rₛ′, defining a strong pull-down connection towards the ground terminal GND; and a second pull-down resistive element 21, having a respective second resistance value R_{w}′, defining a weak pull-down connection towards the same ground terminal GND (the respective second resistance value R_{w}′ being higher than the first resistance value Rₛ′, for example even by two orders of magnitude higher).

In particular, the first resistance value Rₛ, Rₛ′, defining the strong pull-up/down connection is selected with a lower value than the value of the pull-up/down internal resistance of the digital I/O stage 15 used for the detection operations, but at the same time higher than an output impedance with which the same digital I/O stage 15 drives the SA pin at the output.

Furthermore, the second resistance value R_{w}, R_{w}′, defining the weak pull-up/down connection is selected with a higher value than the value of the pull-up/down internal resistance of the digital I/O stage 15 used for the detection operations.

In general, the resistance values are determined such that in a more unfavorable condition the resistive divider between the internal pull-up and the external pull-down (R_{w}′) allows obtaining a voltage on the SA pin greater than a minimum threshold to identify an input signal as high and therefore detect the change of state of the SA pin (the value of this minimum threshold will be indicated below as V_{IH}). A similar argument applies when considering the relationship between internal pull-down and external pull-up (R_{w}).

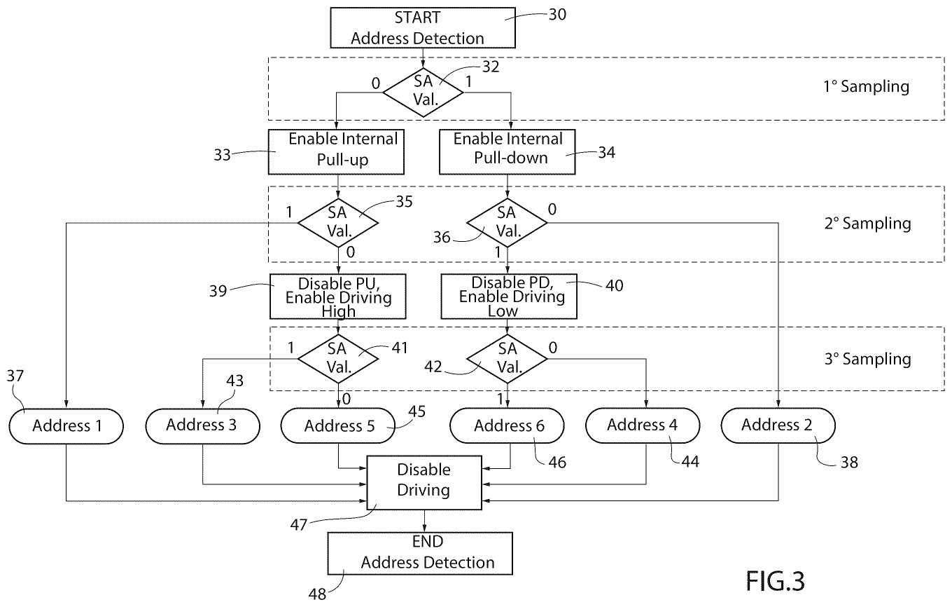

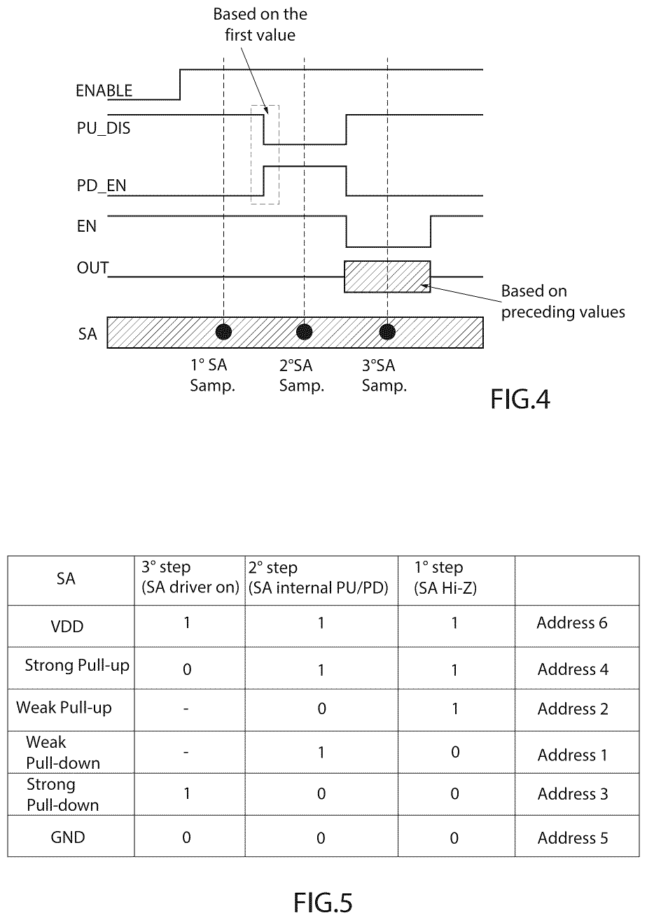

With reference to FIGS. 3 and 4, a possible operation of the detection stage 6 is now described, in particular of the corresponding digital logic unit 14, for determining the different connection modes of the SA pin and the corresponding static addresses (in the example, in a number equal to six).

As indicated in block 30, an address detection logic is first enabled, for example by switching an enable signal ENABLE (shown in FIG. 4), received from the digital logic unit 14, to a high logic value. Alternatively, such enabling may be automatic, for example occurring at each power-on of the corresponding slave device 4.

Then, a first detection step is performed, which envisages determining a first bit (bit 0) of the address signal associated with the SA pin, by sampling a first value or level (of voltage, referred to the ground terminal GND) of the SA pin, as indicated in block 32.

In particular, the digital I/O stage 15 is in this case configured as an input without enabling the embedded pull-up or pull-down. The aforementioned first sampled value determines whether the SA pin is connected to the supply terminal V_{DD} or to the ground terminal GND and therefore determines the high, respectively, low value of the first address bit.

In case the first sampled value is low (‘0’) the internal pull-up is enabled, block 33; otherwise, in case the first sampled value is high (‘1’) the internal pull-down is enabled, block 34, in the aforementioned digital I/O stage 15 (still configured as input).

A second detection step is then performed, which envisages determining a second address bit (bit 1), by sampling a second value of the SA pin, as indicated in block 35, following the aforementioned block 33, or in block 36, following block 34.

If this second value has changed with respect to the first value (for example being high with the first value low, or vice versa), the SA pin is assumed to be connected to the supply terminal V_{DD} or to the ground terminal GND through a weak pull-up/down, defined by the pull-up stage 10 or by the pull-down stage 12.

In this case the method achieves the determination, block 37 following block 35, of a first address (Address 1, given by the bits ‘01’), which therefore corresponds to the presence externally of a weak pull-up; or the determination, block 38 following block 36, of a second address (Address 2, given by the bits ‘10’), which therefore corresponds to the presence externally of a weak pull-down.

If, instead, the aforementioned second value has not changed with respect to the first value, the SA pin is assumed to be connected to the supply terminal V_{DD} or to the ground terminal GND through a strong pull-up/down, or to be connected directly to the supply terminal V_{DD} or to the ground terminal GND.

The method then proceeds to a following step, wherein the digital I/O stage 15 is configured for driving the output at the high state, with the embedded pull-up disabled (block 39 following block 35); or for driving the output at the low state, with the embedded pull-down disabled (block 40 following block 36).

In particular, driving of the output pin by the digital I/O stage 15 is enabled by a signal EN which switches its value (e.g., from high to low, as depicted in the aforementioned FIG. 4).

A third detection step is then performed, which envisages the determination of a third address bit (bit 2), by sampling a third value of the SA pin, as indicated in block 41, following the aforementioned block 39, or in block 42, following block 40.

If this third value has changed with respect to the second value, the SA pin is assumed to be connected to the supply terminal V_{DD} or to the ground terminal GND through a strong pull-up/down (the digital I/O stage 15 is in this case able to “move” the output line by virtue of the previously indicated ratio between the internal and external pull-up/pull-down resistances).

In this case the method achieves the determination, block 43 following block 41, of a third address (Address 3, given by the bits ‘001’), which therefore corresponds to the presence externally of a strong pull-down; or to the determination, block 44 following block 42, of a fourth address (Address 4, given by bits ‘110’), which therefore corresponds to the presence externally of a strong pull-up.

If, instead, the aforementioned third value has not changed with respect to the second value, the SA pin is assumed to be connected directly to the supply terminal V_{DD} or to the ground terminal GND (in this case, the digital I/O stage 15 is unable to “move” the output line, again by virtue of the resistance values previously discussed).

In this case, the method achieves the determination, block 45 following block 41, of a fifth address (Address 5, given by the bits ‘000’), which therefore corresponds to the presence externally of a direct connection to the ground terminal GND; or the determination, block 46 following block 42, of a sixth address (Address 6, given by the bits ‘111’), which therefore corresponds to the presence externally of a direct connection to the supply terminal V_{DD}.

Following the determination of any of the aforementioned static addresses, the driving of the output pin is then disabled (the signal EN switches its value again, in the example from low to high), as indicated in block 47; after which, block 48, the address detection procedure ends.

FIG. 5 illustrates a summary table, which reports the aforementioned addresses (Address 1-6) and the corresponding pull-up/down or driving conditions of the SA pin. The three address detection steps are also summarized: the first step to which a high impedance (Hi-Z) associated with the SA pin corresponds; the second step, with the enabling of the internal pull-up/down, having the SA pin coupled thereto; and the third step with the enabling of the output driving (‘driver’).

Some further considerations are now made as regards the aforementioned first resistance value Rₛ, Rₛ′ and second resistance value R_{w}, R_{w}′, defining the strong or weak pull-up/down connection for the SA pin.

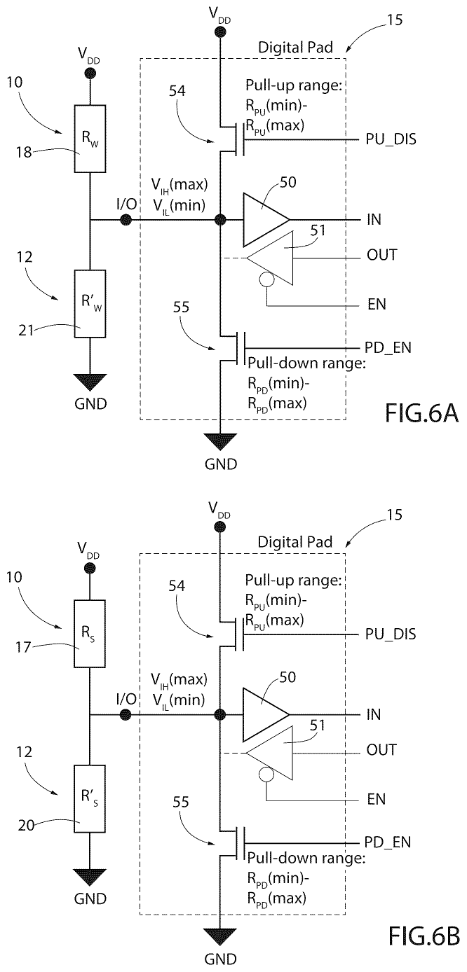

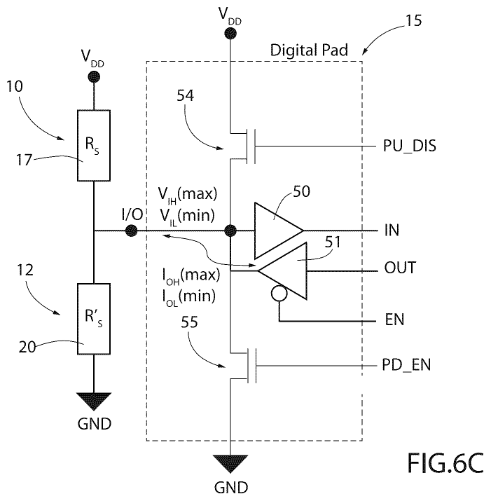

In particular, FIG. 6A first refers to the definition of a minimum value for the second resistance value R_{w}, R_{w}′, which determines the weak pull-up/down connection.

In this FIG. 6A a possible implementation of the digital I/O stage 15 is also shown, which in this case comprises an input buffer 50 and an output buffer 51 connected to the SA pin (the output buffer 51 receiving the signal EN, in this case such as to disable driving of the output line).

The digital I/O stage 15 is also provided with a pull-up internal resistive element, in this case defined by a pull-up transistor 54, coupled between the SA pin and the supply terminal V_{DD} and controlled by a pull-up enable signal PU_DIS (shown in the aforementioned FIG. 4).

The pull-up internal resistance is in this case defined by the drain-source resistance of such pull-up transistor 54 and has a value which may vary (as a function of the process conditions, temperature or further factors) in a range going from a minimum value R_{PU}(min) to a maximum value R_{PU}(max).

Similarly, the digital I/O stage 15 is provided with a pull-down internal resistive element, in this case defined by a pull-down transistor 55, coupled between the SA pin and the ground terminal GND and controlled by a pull-down enable signal PD_EN (also shown in the aforementioned FIG. 4).

The pull-down internal resistance is in this case defined by the drain-source resistance of such pull-down transistor 55 and has a value which may vary (as a function of the process conditions, temperature or further factors) in a range going from a minimum value RPD (min) to a maximum value RPD (max).

In FIG. 6A the second pull-up resistive element 18, having the second resistance value R_{w}; and the second pull-down resistive element 21, having the respective second resistance value R_{w}′, are also shown.

The following expressions may be used for defining the minimum value for the aforementioned second resistance value R_{w}, which determines the weak pull-up connection:

$$\frac{{V}_{DD} * {R}_{PD} ( max )}{{R}_{W} ( min ) + {R}_{PD} ( max )} ≪ {V}_{IL} ( min )$$

$${V}_{DD} * {R}_{PD} ( max ) ≪ {V}_{IL} ( min ) * ( {R}_{W} ( min ) + {R}_{PD} ( max ) )$$

$${R}_{W} ( min ) ≫ \frac{( {V}_{DD} - {R}_{IL} ( min ) ) * {R}_{PD} ( max )}{{R}_{IL} ( min )}$$

where V_{IL}(min) indicates the lower limit value for the recognition of the low logic value or level of the SA pin (since this value is subject, like any technological parameter, to variations with process, temperature and voltage, the most unfavorable condition is considered).

Similarly, the following expressions may be used for defining the minimum value for the second resistance value R_{w}′, which determines the weak pull-down connection:

$$\frac{{V}_{DD} * {R}_{W} ( min )}{{R}_{W} ( min ) + {R}_{PU} ( max )} ≫ {V}_{IH} ( max )$$

$${V}_{DD} * {R}_{W} ( min ) ≫ {V}_{IH} ( max ) * ( {R}_{W} ( min ) + {R}_{PU} ( max ) )$$

$${R}_{W} ( min ) ≫ \frac{{V}_{IH} ( max ) ) * {R}_{PU} ( max )}{( {V}_{DD} - {V}_{IH} ( max ) )}$$

where V_{IH}(max) indicates the upper limit value for the recognition of the high logic value of the SA pin (corresponding again to the most unfavorable condition).

With reference to FIG. 6B, some further considerations are now presented referring to the definition of a maximum value for the first resistance value Rₛ, Rₛ′ which determines the strong pull-up/down connection (also in this case the output buffer 51 is disabled by the signal EN).

In FIG. 6B, the first pull-up resistive element 17, having the first resistance value Rₛ; and the first pull-down resistive element 20, having the respective first resistance value Rₛ′, are thus shown.

The following expressions may in this case be used for defining the maximum value for the first resistance value Rₛ, which determines the strong pull-up connection:

$$\frac{{V}_{DD} * {R}_{PD} ( min )}{{R}_{S} ( max ) + {R}_{PD} ( min )} ≫ {V}_{IH} ( max )$$

$${V}_{DD} * {R}_{PD} ( min ) ≫ {V}_{IH} ( max ) * ( {R}_{S} ( max ) + {R}_{PD} ( min ) )$$

$${R}_{S} ( max ) ≪ \frac{( {V}_{DD} * - {R}_{IH} ( max ) ) * {R}_{PD} ( min )}{{R}_{IH} ( max )}$$

Similarly, the following expressions may be used for defining the maximum value for the second resistance value Rₛ′, which determines the strong pull-down connection:

$$\frac{{V}_{DD} * {R}_{S} ( max )}{{R}_{S} ( max ) + {R}_{PU} ( min )} ≪ {V}_{IL} ( min )$$

$${V}_{DD} * {R}_{S} ( max ) ≪ {V}_{IL} ( min ) * ( {R}_{S} ( max ) + {R}_{PU} ( min ) )$$

$${R}_{S} ( max ) ≪ \frac{{V}_{IL} ( min ) ) * {R}_{PU} ( min )}{( {V}_{DD} - {V}_{IL} ( min ) )}$$

With reference to FIG. 6C, further considerations are finally presented referring to the definition of a minimum value for the first resistance value Rₛ, Rₛ′ which determines the strong pull-up/down connection (in this case with the output buffer 51 which is enabled by the signal EN to drive the output line):

$${V}_{DD} - {I}_{OL} ( min ) * {R}_{S} ( min ) ≪ {V}_{IL} ( min )$$

$${R}_{S} ( min ) ≫ \frac{{V}_{DD} - {V}_{IL} ( min )}{{I}_{OL} ( min )}$$

$$and :$$

$${I}_{OH} ( min ) * {R}_{S} ( min ) ≫ {V}_{IH} ( max )$$

$${R}_{S} ( min ) ≫ \frac{{V}_{IH} ( max )}{{I}_{OH} ( min )}$$

where I_{OL}(min) indicates a lower limit value for the current drawn with driving of the SA pin at the low logic value; and Ion (min) indicates a lower limit value for the current supplied with driving of the same SA pin at the high logic value (these values corresponding to the respective most unfavorable conditions).

The advantages of the proposed solution are clear from the preceding disclosure.

In any case, it is underlined that this solution is simple to implement, with a low cost; it does not require the implementation of ADC converters or complex external networks; it only requires the use of standard resistors (or similar resistive elements) as external components; it does not require specific test or characterization procedures; it may be applied to devices having small size and a low number of pins; it requires a very small implementation area.

The proposed solution also has high flexibility, since the system may be applied to any communication interface with a static address.

Finally, it is clear that modifications and variations may be made to what has been described and illustrated here without thereby departing from the scope of the present invention, as defined in the attached claims.

In particular, it is again underlined that the solution described may also be advantageously implemented for other digital interface protocols (other than the 13C protocol), requiring the assignment of static addresses to a certain number of slave devices (even identical devices) coupled to a same digital communication bus. Furthermore, it is underlined that the number of recognized addresses may be adapted based on the features of the digital pins (availability of different pull-up/down resistances, different driving features).

What is claimed is:

1. A digital system comprising:
a master device;
a shared data communication bus; and
a plurality of slave devices coupled to the master device on the shared data communication bus, each slave device comprising:
an address selection pin, configured to be addressed by the master device for a data communication on the shared data communication bus; and
a detection stage, coupled to the address selection pin and configured to determine a static address associated with the address selection pin as a function of a respective one of different pull-up and/or pull-down connection modes of the address selection pin, wherein the different pull-up and/or pull-down connection modes differ from each other based on a different resistance associated with each pull-up and/or pull-down connection.

2. The digital system according to claim 1, wherein each slave device comprises a single address selection pin, and the detection stage is configured to detect a plurality of different connection modes of the single address selection pin corresponding to respective different static addresses, the different connection modes comprising:
the single address selection pin directly connected to a supply terminal;
the single address selection pin connected to the supply terminal through a weak pull-up;
the single address selection pin connected to the supply terminal through a strong pull-up;
the single address selection pin connected to a ground reference terminal through a strong pull-down;
the single address selection pin connected to the ground reference terminal through a weak pull-down; and
the single address selection pin directly connected to the ground reference terminal.

3. The digital system according to claim 1, further comprising, externally to each slave device, a respective pull-up stage, configured to be coupled to the address selection pin of the slave device and configured to define at least two different pull-up connection modes of the address selection pin of the slave device towards a supply terminal, wherein the different pull-up connection modes correspond to a strong pull-up connection towards the supply terminal via a first pull-up resistance value, and a weak pull-up connection towards the supply terminal via a second pull-up resistance value higher than the first pull-up resistance value.

4. The digital system according to claim 3, further comprising, externally to each slave device, a respective pull-down stage, configured to be coupled to the address selection pin of the slave device and configured to define at least two different pull-down connection modes of the address selection pin of the slave device towards a ground terminal, wherein the different pull-down connection modes correspond to a strong pull-down connection towards the ground terminal via a first pull-down resistance value, and a weak pull-down connection towards the ground terminal via a second pull-down resistance value higher than the first pull-down resistance value.

5. The digital system according to claim 1, wherein the detection stage of each slave device is configured to implement a sequence of checks on a value associated with its address selection pin to detect the respective pull-up and/or pull-down connection mode of its address selection pin and, consequently, the static address assigned to the respective slave device.

6. The digital system according to claim 5, wherein the detection stage comprises a digital logic unit configured to implement a finite state machine to perform the sequence of checks.

7. The digital system according to claim 5, wherein each slave device comprises a digital input/output stage, connected to its address selection pin and provided with an embedded controllable pull-up and/or pull-down feature, wherein the detection stage is operatively coupled to the digital input/output stage and is configured to control the digital input/output stage during, and as a function of, the sequence of checks.

8. The digital system according to claim 7, wherein the digital input/output stage is configured to selectively implement a pull-up or pull-down internal resistance, and wherein a first pull-up/down resistance value defining a strong pull-up/down connection mode of the address selection pin externally to the slave device is lower than a value of the pull-up or pull-down internal resistance and higher than a driving output impedance of the digital input/output stage.

9. The digital system according to claim 8, wherein a second pull-up/down resistance value defining a weak pull-up/down connection mode of the address selection pin externally to the slave device is higher than the value of the pull-up or pull-down internal resistance of the digital input/output stage.

10. The digital system according to claim 8, wherein the detection stage is configured, during the sequence of checks, to enable or disable the pull-up or pull-down internal resistance and determine the respective pull-up and/or pull-down connection mode of the address selection pin based on variations of the value associated with the address selection pin with the pull-up or pull-down internal resistance enabled, or disabled.

11. The digital system according to claim 10, wherein the detection stage is configured, during the sequence of checks, to enable or disable a driving output of the digital input/output stage and determine the respective pull-up and/or pull-down connection mode of the address selection pin also based on variations of the value associated with the address selection pin with the driving output enabled, or disabled.

12. The digital system according to claim 11, wherein the detection stage is configured to:
in a first step of the sequence of checks, disable the pull-up or pull-down internal resistance, sample a first value associated with the address selection pin and use the first value to define a first bit of the static address;
in a second step of the sequence of checks, enable the pull-up or pull-down internal resistance as a function of the first value, sample a second value associated with the address selection pin and use the second value to define a second bit of the static address; and
in a third step of the sequence of checks, disable the pull-up or pull-down internal resistance, enable the driving output of the digital input/output stage, high or low as a function of the first value associated with the address selection pin, and sample a third value associated with the address selection pin and use the third value to define a third bit of the static address.

13. The digital system according to claim 1, wherein the shared data communication bus is a serial interface bus operating with I2C or I3C protocol.

14. An address assigning method in a digital system comprising a master device and a plurality of slave devices coupled to the master device on a shared data communication bus, the method comprising:
addressing each slave device, by a corresponding address selection pin, for a communication on the shared data communication bus; and
detecting, by each slave device, a static address associated with the respective address selection pin as a function of a respective one of different pull-up and/or pull-down connection modes of the respective address selection pin, the different pull-up and/or pull-down connection modes differing from each other based on a different resistance associated with each pull-up and/or pull-down connection.

15. The method according to claim 14, wherein each of the slave devices comprises a single address selection pin and the detecting comprises:
determining a plurality of different connection modes of the single address selection pin corresponding to respective different static addresses, the different connection modes comprising:
the single address selection pin directly connected to a supply terminal;
the single address selection pin connected to the supply terminal through a weak pull-up;
the single address selection pin connected to the supply terminal through a strong pull-up;
the single address selection pin connected to a ground reference terminal through a strong pull-down;
the single address selection pin connected to the ground reference terminal through a weak pull-down; and
the single address selection pin directly connected to the ground reference terminal.

16. The method according to claim 14, further comprising:
coupling a respective pull-up stage, external to each slave device, to the address selection pin of the slave device; and
defining at least two different pull-up connection modes of the address selection pin of the slave device towards a supply terminal, the different pull-up connection modes corresponding to a strong pull-up connection towards the supply terminal via a first pull-up resistance value, and a weak pull-up connection towards the supply terminal via a second pull-up resistance value higher than the first pull-up resistance value.

17. The method according to claim 16, further comprising:
coupling a respective pull-down stage, external to each slave device, to the address selection pin of the slave device; and
defining at least two different pull-down connection modes of the address selection pin of the slave device towards a ground terminal, the different pull-down connection modes corresponding to a strong pull-down connection towards the ground terminal via a first pull-down resistance value, and a weak pull-down connection towards the ground terminal via a second pull-down resistance value higher than the first pull-down resistance value.

18. The method according to claim 14, further comprising implementing, by a detection stage of each slave device, a sequence of checks on a value associated with its address selection pin to detect the respective pull-up and/or pull-down connection mode of its address selection pin and, consequently, the static address assigned to the respective slave device.

19. The method according to claim 18, further comprising implementing, by a digital logic unit of the detection stage, a finite state machine to perform the sequence of checks.

20. The method according to claim 18, wherein each slave device comprises a digital input/output stage, connected to its address selection pin and provided with an embedded controllable pull-up and/or pull-down feature, the method further comprising:
operatively coupling the detection stage to the digital input/output stage; and
controlling the digital input/output stage during, and as a function of, the sequence of checks.
